(19) United States
(12) Patent Application Publication
(10) Pub. No.: US 2007/0166504 A1
(43) Pub. Date: Jul. 19, 2007

(54) OPTICAL DISC

(76) Inventors: Chen Peng, Taipei City (TW); Hung-Chuan Cheng, Longtan Township (TW); Yao-Wen Chang, Fongshan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/421,101

(22) Filed: May 31, 2006

(30) Foreign Application Priority Data
Jan. 13, 2006 (TW) 095101486

(51) Int. Cl. B32B 3/02

(52) U.S. Cl. 428/64.4

(57) ABSTRACT

The present invention provides an optical disc which includes a substrate and a multi-layer structure. Furthermore, the multi-layer structure is formed above the substrate, and at least one layer of the multi-layer structure contains an anti-oxidant material.

### BACKGROUND OF THE INVENTION

1. Field of the Invention

The present invention relates generally to an optical disc and, more particularly, to an optical disc which contains an anti-oxidant material.

2. Description of the Prior Art

The modern information revolution has led to an ever increasing demand for data storage systems. To this end, the extremely low cost per megabyte, mature technology, small size, and convenient handling of optical storage media, e.g., CD-R, CD-RW, DVD±R, DVD-RW, has resulted in the explosive growth of their use as a data storage and distribution medium. The user can easily apply these medium to store enormous amounts of movies, music, pictures or data.

However, because of the convenience of these optical storage media, users easily ignore the preservation environment of these media. Therefore, these optical storage media may be deteriorated by environment factors such as high humidity, increased temperature, light exposure and oxidation, and then be unreadable. Moreover, since pure silver and alloy target material both are the major material of reflecting layer in these optical storage media, effect of oxidation becomes a serious problem that must be solved.

Obviously, it is important to improve the anti-oxidation ability of these optical storage media to reduce the oxidation rate, and increase the life span of these media.

### SUMMARY OF THE INVENTION

Accordingly, the present invention pertains to an optical disc with anti-oxidant ability. In one preferred embodiment of the present invention, the optical disc includes a substrate and a multi-layer structure. The multi-layer structure is formed over the substrate, and at least one layer of the multi-layer structure contains an anti-oxidant material.

In another preferred embodiment of the present invention, the optical disc includes a first substrate, a multi-layer structure and a second substrate. Additionally, the multi-layer structure is formed over the first substrate, and at least one layer of the multi-layer structure containing an anti-oxidant material. Moreover, the second substrate is formed over the multi-layer structure.

The advantage and spirit of the invention may be understood by the following recitations together with the appended drawings.

### BRIEF DESCRIPTION OF THE APPENDED DRAWINGS

FIG. 1 is a sectional view of an optical disc 1 according to an embodiment of the present invention.

FIG. 2 is a sectional view of an optical disc 1 according to an embodiment of the present invention.

FIG. 3 is a sectional view of an optical disc 3 according to an embodiment of the present invention.

FIG. 4 is a sectional view of an optical disc 3 according to an embodiment of the present invention.

### DETAILED DESCRIPTION OF THE INVENTION

The present invention provides an optical disc, and more particularly, the optical disc contains an anti-oxidant material therein. Reference will now be made in detail to the present preferred embodiments of the present invention, examples of which are illustrated in the accompanying drawings, wherein like reference numerals refer to the like elements throughout. The embodiments are described below in order to explain the present invention by reference to the figures.

An optical disc according to a preferred embodiment of the present invention includes a substrate and a multi-layer structure. The multi-layer structure is formed over the substrate, and at least one layer of the multi-layer structure contains an anti-oxidant material.

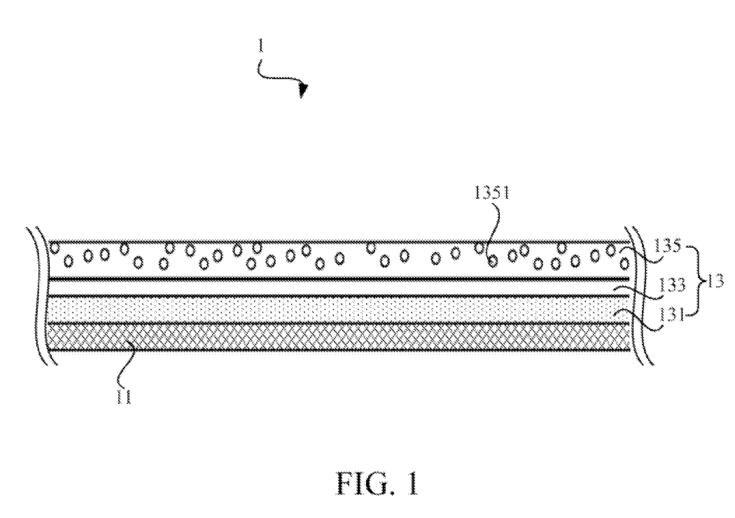

Please refer to FIG. 1. FIG. 1 is a sectional view of an optical disc 1 according to an embodiment of the present invention. The optical disc 1 includes the substrate 11 and the multi-layer structure 13 as described above. The multi-layer structure 13 further includes a recording layer 131, a reflecting layer 133 and a surface layer 135. Moreover, in the embodiment, the surface layer 135 contains the anti-oxidant material 1351. In practice, the anti-oxidant material can be hydroquinone, erythorbic acid, erythorbic acid salt, ascorbic acid, ethoxyquin, and the like. Particularly, the concentration of the anti-oxidant material in the surface layer 135 is between 0.1 wt % to 15 wt %, and preferred between 0.5 wt % to 3 wt %, for example, 1 wt %, 2 wt %, or 3 wt %.

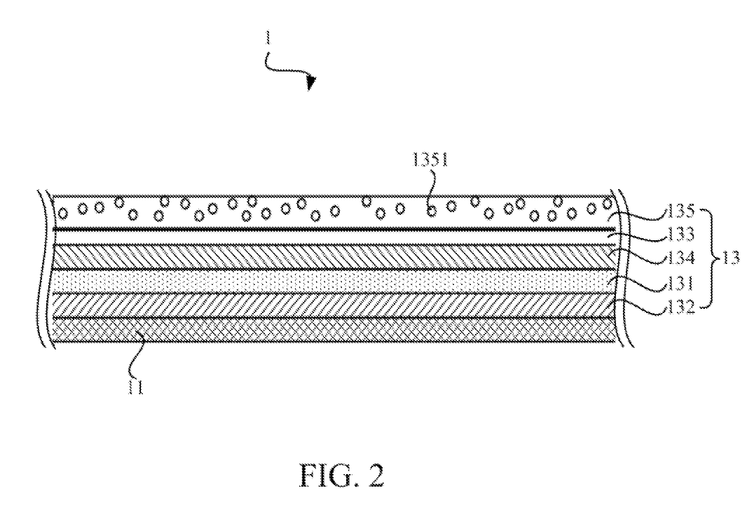

Referring to FIG. 2, FIG. 2 shows an optical disc 1 of another embodiment of the invention. The optical disc 1 also includes the substrate 11 and the multi-layer structure 13. In addition, the multi-layer structure 13 further includes a recording layer 131, a reflecting layer 133, a surface layer 135, a first dielectric layer 132 and a second dielectric layer 134. Particularly, in the embodiment, the surface layer 135 contains the anti-oxidant material 1351.

In practice, as described above, the anti-oxidant material can be hydroquinone, erythorbic acid, erythorbic acid salt, ascorbic acid, ethoxyquin, and the like. Particularly, the concentration of the anti-oxidant material in the surface layer 135 is between 0.1 wt % to 15 wt %, and preferred between 0.5 wt % to 3 wt %.

Additionally, in another embodiment, the anti-oxidant material can be contained in the recording layer. It should be noticed that the optical discs described above can be configured to comply with a CD-R specification or a CD-RW specification.

In another preferred embodiment of the present invention, an optical disc includes a first substrate, a multi-layer structure and a second substrate is disclosed. The multi-layer structure is formed over the first substrate, more particular, at least one layer of it contains an anti-oxidant material. Furthermore, the second substrate is formed over the multi-layer structure, so the multi-layer structure is located between the first substrate and the second substrate.

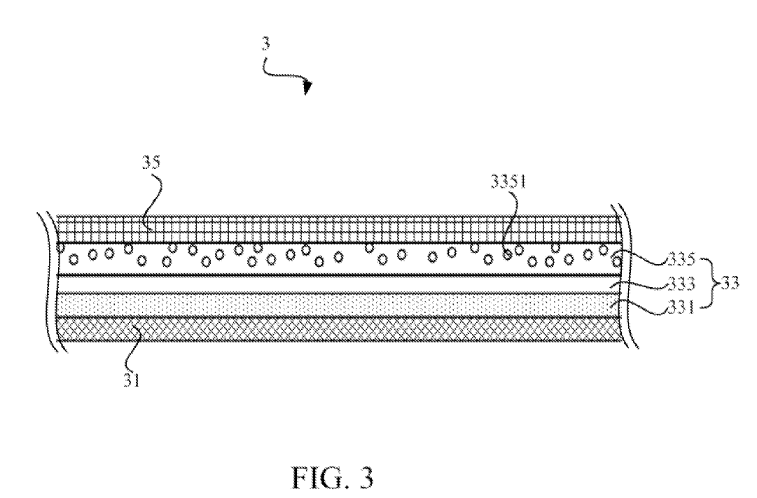

Please refer to FIG. 3, which shows an optical disc 3 according to an embodiment of the present invention. The optical disc 3 includes a first substrate 31, a multi-layer structure 33, and a second substrate 35. Moreover, the multi-layer structure 33 further includes a recording layer 331, a reflecting layer 333, and a bonding layer 335. More particularly, in the embodiment, the bonding layer 335 contains the anti-oxidant material 3351.

In practice, as described above, the anti-oxidant material can be hydroquinone, erythorbic acid, erythorbic acid salt, ascorbic acid, ethoxyquin, and the like. Particularly, the concentration of the anti-oxidant material in the bonding layer 335 is between 0.1 wt % to 15 wt %, and preferred between 0.5 wt % to 3 wt %.

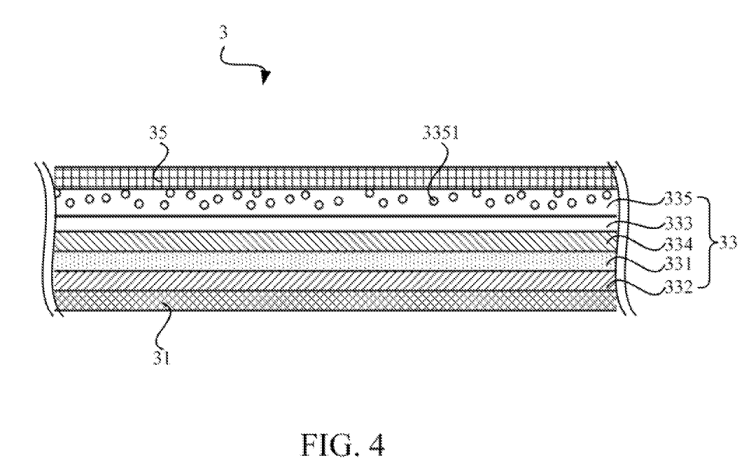

Please refer to FIG. 4, an optical disc 3 in accordance with another embodiment of the present invention also includes the first substrate 31, the multi-layer structure 33, and the second substrate 35. Moreover, the multi-layer structure 33 further includes a recording layer 331, a reflecting layer 333, a bonding layer 335, a first dielectric layer 332, and a second dielectric layer 334. Particularly, in the embodiment, the bonding layer 335 contains the anti-oxidant material 3351.

In practice, as described above, the anti-oxidant material can be hydroquinone, erythorbic acid, erythorbic acid salt, ascorbic acid, ethoxyquin, and the like. Particularly, the concentration of the anti-oxidant material in the bonding layer 335 is between 0.1 wt % to 15 wt %, and preferred between 0.5 wt % to 3 wt %.

Additionally, in another embodiment of the invention, the anti-oxidant material can be contained in the recording layer. It should be noticed that the optical discs described above can be configured to comply with a DVD-R, a DVD+R, a DVD-RW or a DVD+RW specification.

Obviously, through the addition of the anti-oxidant material, the lifespan of the optical disc of the prevent invention can be elongated. Particularly, the production cost and quality of the anti-oxidant material added optical disc of the present invention are almost the same as conventional optical disc.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical disc, comprising:
a substrate; and
a multi-layer structure formed over the substrate, at least one layer of the multi-layer structure containing an anti-oxidant material.

2. The optical disc of claim 1, wherein the anti-oxidant material is one selected from the group consisting of a hydroquinone, an erythorbic acid, an erythorbic acid salt, an ethoxyquin and their mixtures.

3. The optical disc of claim 2, wherein the at least one layer containing the anti-oxidant material comprises a surface layer of the multi-layer structure.

4. The optical disc of claim 3, wherein the concentration of the anti-oxidant material is between 0.1 wt % to 15 wt %.

5. The optical disc of claim 3, wherein the concentration of the anti-oxidant material is between 0.5 wt % to 3 wt %.

6. The optical disc of claim 2, wherein the at least one layer containing the anti-oxidant material comprises a recording layer of the multi-layer structure.

7. The optical disc of claim 6, wherein the concentration of the anti-oxidant material is between 0.1 wt % to 15 wt %.

8. The optical disc of claim 6, wherein the concentration of the anti-oxidant material is between 0.5 wt % to 3 wt %.

9. The optical disc of claim 1, wherein the optical disc is configured to comply with a CD-R specification or a CD-RW specification.

10. An optical disc, comprising:
a first substrate;
a multi-layer structure formed over the first substrate, at least one layer of the multi-layer structure containing an anti-oxidant material; and
a second substrate, formed over the multi-layer structure.

11. The optical disc of claim 10, wherein the anti-oxidant material is one selected from the group consisting of a hydroquinone, an erythorbic acid, an erythorbic acid salt, an ethoxyquin and their mixtures.

12. The optical disc of claim 11, wherein the at least one layer containing the anti-oxidant material comprises a bonding layer of the multi-layer structure.

13. The optical disc of claim 12, wherein the concentration of the anti-oxidant material is between 0.1 wt % to 15 wt %.

14. The optical disc of claim 12, wherein the concentration of the anti-oxidant material is between 0.5 wt % to 3 wt %.

15. The optical disc of claim 11, wherein the at least one layer containing the anti-oxidant material comprises a recording layer of the multi-layer structure.

16. The optical disc of claim 15, wherein the concentration of the anti-oxidant material is between 0.1 wt % to 15 wt %.

17. The optical disc of claim 15, wherein the concentration of the anti-oxidant material is between 0.5 wt % to 3 wt %.

18. The optical disc of claim 10, wherein the optical disc is configured to comply with a DVD-R specification or a DVD+R specification.

19. The optical disc of claim 10, wherein the optical disc is configured to comply with a DVD-RW.
